(19) United States
(12) Patent Application Publication
(10) Pub. No.: US 2021/0241742 A1
(43) Pub. Date: Aug. 5, 2021

(54) MANUALLY RECHARGEABLE AIR HORN

(71) Applicant: ALAN RICHARD GREENBERG, LOS ANGELES, CA (US)

(72) Inventor: ALAN RICHARD GREENBERG, LOS ANGELES, CA (US)

(21) Appl. No.: 16/913,827

(22) Filed: Jun. 26, 2020

Related U.S. Application Data
(60) Provisional application No. 62/968,763, filed on Jan. 31, 2020.

(51) Int. Cl. G10K 9/04

(52) U.S. Cl. CPC G10K 9/04

(57) ABSTRACT

The present invention is a portable air horn apparatus including: a housing; an air horn assembly for generating sound, the air horn being mounted in the housing and receiving air from a small tank. An internal pump fills a small inline tank by means of a one way valve, and a release button sends the air through a diaphragm through the air horn. The air supply of the inline tank is rechargeable by means of an internal hand operated pump, in order to maintain the necessary supply of air required to produce adequate sound.

### PRIORITY CLAIMS

This application claims the benefit of U.S. Provisional Application Ser. No. 62/968,763 filed on Jan. 31, 2020, the contents of which are incorporated herein by reference.

### BACKGROUND OF THE INVENTION

An air horn is a pneumatic device designed to create an extremely loud noise for signaling purposes. It usually consists of a source which produces compressed air, which passes into a horn through a reed or diaphragm. The stream of air causes the reed or diaphragm to vibrate, creating sound waves, then the horn amplifies the sound making it louder.

An air horn consists of a flaring metal or plastic horn or trumpet (called the “bell”) attached to a small air chamber containing a metal or plastic reed or diaphragm in the throat of the horn. Compressed air flows from an inlet line through a narrow opening past the reed or diaphragm, causing it to vibrate, which creates sound waves. The flaring horn serves as an acoustic “transformer” to improve the transfer of sound energy from the diaphragm to the open air, making the sound louder. In most horns it also determines the pitch of the sound. When vibrated by the diaphragm, the column of air in the horn vibrates in standing waves. The length of the horn determines the wavelength of the sound waves generated, and thus the fundamental frequency (pitch) of the note produced by the horn. The longer the horn, the lower the pitch.

A very common kind of portable air horn apparatus consists of an air horn attached to a valve device that can be fitted to the neck of a compressed gas canister.

The valve device includes a trigger that, when operated, allows compressed gas from the canister to operate the air horn. Hand-held air horn devices operate with use of a compressed gas released from a high-pressure canister (the gases) may be compressed air, butane, Hydro Fluoro Carbon (HFC) 134 A gas (Environmentally Safe Freon), Freon® 22 as an HCFC refrigerant, and any other type of compressed gas combinations.

Devices of this kind are relatively inexpensive and lightweight and can generate sound at a high volume. However, gas canisters contain a finite amount of compressed gas that allows only a few uses before the canister has to be changed. Even worse, the valve devices tend to allow leakage of the gas from the canisters, thus further reducing the number of uses of the device before replacement of the canister is necessary. Gas leakage can also lead costly or dangerous situations in which an apparatus is unexpectedly found to be inoperative due to leakage and necessary warnings cannot be given, at least until a new canister can be obtained. The unreliability of apparatus of this kind makes it unsuitable for professional use.

Specifically, conventional air horn devices should be configured to have excellent sealing characteristics so as to prevent compressed fluid from leaking though the housing of the device, risking functional loss, poisoning, staining, and other detriments noted below. Additionally, the accidental loss of gas pressure renders an air horn non-functional, and the slow loss of pressure (via a slow leak), results in a steadily decreasing audio output. Structural countermeasures directed to minimization of the above-discussed problems often lead to an overly complicated structure of the device that may be cost-prohibitive.

There exists a need for a portable air horn that eliminates the need to store dangerous compressed gas and also a dependable, rechargeable air supply for which to generate the sound.

### SUMMARY OF THE INVENTION

The present invention is a portable air horn apparatus including: a housing; an air horn assembly for generating sound, the air horn being mounted in the housing and receiving air from a small tank. An internal pump fills a small inline tank by means of a one way valve, and a release button sends the air through a diaphragm through the air horn.

In one embodiment of the present invention, the air supply of the inline tank is rechargeable by means of an internal hand operated pump, in order to maintain the necessary supply of air required to produce adequate sound. The manual pump act as a plunger that forces air into the one-way valve. The one-way valve fills the inline tank with enough air to create a compression effect without letting any air escape the storage tank. Once the storage tank is filled with a sufficient amount of air to generate a compression effect, the air can be released through the diaphragm by means of pressing down to open the top valve. This will generate a loud and consistent sound through the diaphragm.

These and other aspects, objects, features and advantages of the present invention, are specifically set forth in, or will become apparent from, the following detailed description of an exemplary embodiment of the invention.

### BRIEF DESCRIPTION OF THE DRAWINGS

FIG. 1 is a rendering of the present invention.

FIG. 2 is a diagram of the process of the present invention.

### DETAILED DESCRIPTION OF THE PREFERRED EMBODIMENT

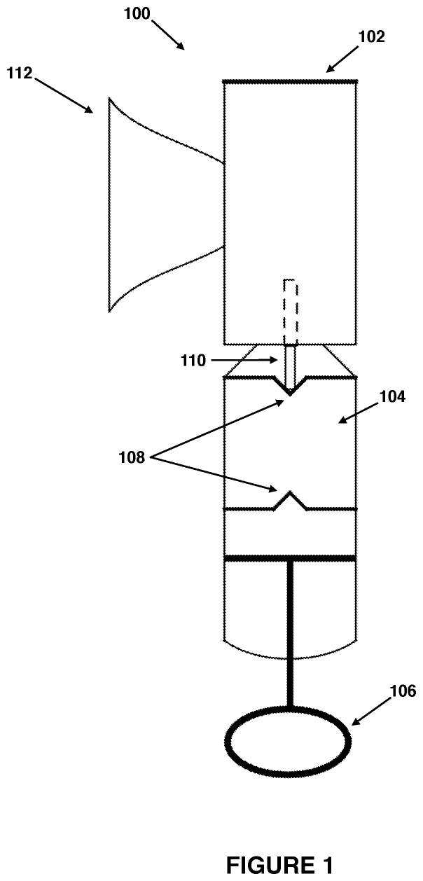

FIG. 1 is a rendering of the present invention. In accordance with the preferred embodiment of the present invention, the manually rechargeable air horn apparatus 100 is comprised of: a release valve 102; an inline tank filled with compressed air 104; a manual hand operated plunger pump 106; a one way valve 108; an air feeder connecting device 110; and a diaphragm 112. The device recharges by the hand operated pump 106 that acts as a plunger drawing in air into the tank 104. Air is able to be trapped with being released within the tank 104 by means of a one way valve 108. Once a sufficient amount of air has been collected within the tank 104, it becomes compressed through pressurization. In order to release the compressed air, the release valve 102 located at the top of the device housing is pressed down, and the compressed air travels through a connecting feeder tube 110 that connects the inline tank to the diaphragm 112 housing and released through the diaphragm 112 to produce a loud and consistent sound.

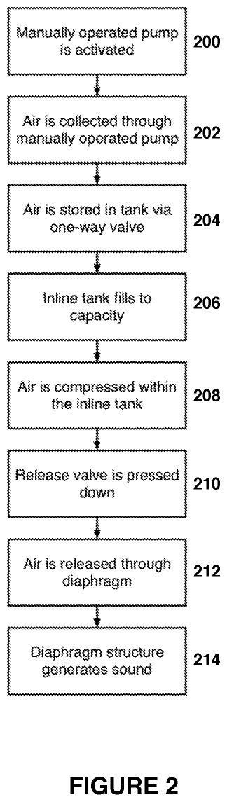

FIG. 2 is a diagram of the process of the present invention. In accordance with the preferred embodiment of the present invention, the manually operated hand pump located on the bottom of the apparatus is activated 200 by pushing air through the plunger. The air is collected through the manually operated pump 202. The air is collected and stored within the inline tank by means of a one-way valve 204. The inline tank fills to capacity 206 allowing for pressurization of the air to occur, and the air is compressed within the tank 208. The release valve located at the top of the apparatus is pressed down 210, allowing the compressed air to be released into the diaphragm housing and through the diaphragm 212. The acoustic structure of the diaphragm generates a loud and consistent horn sound 214.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

What is claimed is:

1. A horn comprising:
a body;
a sound generating unit in the body;
an air chamber for accepting and storing compressed air to activate said sound generating unit;
an air pump activated by a user of said horn forming a part of said body wherein said air pump may be manually compressed to force air into said air chamber for subsequent release to activate said sound generating unit; and
a release valve which may be activated by said user to enable stored compressed air to be released from said air chamber into said sound generating unit for producing sound.

2. A horn, according to claim 1, wherein said release valve is automatically triggered in response to a set amount of pressure being achieved in said air chamber.

3. A horn according to claim 1 wherein a plurality of sound generating units are disposed within said body for producing various sounds.

4. A horn according to claim 3, wherein said user can set in advance of activating said release valve which of sound generating units will be activated upon said release of compressed air.

5. A horn according to claim 1 wherein said air pump includes a squeeze handle for a user to force air into said air chamber.

6. A horn according to claim 1 wherein said air pump includes a push pump for a user to hold said horn body with one hand and use said push pump with the other hand.

7. A horn according to claim 1 wherein said air pump includes a crank pump for a user to hold said horn body with one hand and use said crank pump with the other hand.

8. A method of producing sound from a horn comprising:
producing and activating horn body containing a sound generating unit, an air storage chamber for accepting and storing compressed air to activate said sound generating unit, an air pump activated by a user of said horn wherein said air pump may be manually compressed to force air into said air chamber for subsequent release to activate said sound generating unit, and a release valve which may be activated by said user to enable stored compressed air to be released from said air chamber into said sound generating unit for producing sound.

9. A horn, according to claim 8, wherein said release valve is automatically triggered in response to a set amount of pressure being achieved in said air chamber.

10. A horn according to claim 8 wherein a plurality of sound generating units are disposed within said body for producing various sounds.

11. A horn according to claim 10, wherein said user can set in advance of activating said release valve which of sound generating units will be activated upon said release of compressed air.

12. A horn according to claim 1 wherein said air pump includes a squeeze handle for a user to force air into said air chamber.

13. A horn according to claim 1 wherein said air pump includes a push pump for a user to hold said horn body with one hand and use said push pump with the other hand.

14. A horn according to claim 1 wherein said air pump includes a crank pump for a user to hold said horn body with one hand and use said crank pump with the other hand.
